(19) United States
(12) Patent Application Publication
(10) Pub. No.: US 2002/0051061 A1
(43) Pub. Date: May 2, 2002

(54) Image monitoring

(75) Inventors: Wolfgang Peters, Tamm (DE); Gerhard Schneider, Leonberg (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 09/983,415

(22) Filed: Oct. 24, 2001

(30) Foreign Application Priority Data
Oct. 28, 2000 (DE) 100 53 683.2

(51) Int. Cl. H04N 9/04

(52) U.S. Cl. 348/207; 348/231

(57) ABSTRACT

According to the invention, live images, in particular, from a CCD camera are compressed in two different ways in a monitoring instrument. On the one hand, compression is carried out at a low resolution, for example by means of H.261, H.263 or MPEG. On the other hand, compression is carried out at a high resolution, for example by means of JPEG, synchronously with the compression at the low resolution. A time code is generated for each image. The time code is, for example, a chronological code which contains the date and time of day. The time code can also be generated implicitly via a timer which runs simultaneously. Each image is stored twice, on the one hand as an image compressed at low resolution and, on the other hand, as an image compressed at high resolution. The time codes, which indicate links between corresponding images, are also stored.

### TECHNICAL FIELD

The invention relates to a monitoring system, in particular for image monitoring. The invention is based on a priority application DE 100 53 683.2 which is hereby incorporated by reference.

### BACKGROUND OF THE INVENTION

Analogue cameras are used in current video monitoring systems. The images recorded by the analogue cameras are sent using analogue broadband transmission. The transmission is carried out via separate local networks which have been provided individually for the video transmission systems and are used exclusively therefor. The video resolution of the image transmission is not good enough in the vast majority of cases, in particular for recognizing individuals. In this context, easy recognition could indeed be very useful in the fight against crime. When video monitoring is used in public places, stadiums, metropolitan railway stations etc., it might be possible to identify and pursue thieves, criminals, terrorists etc. An alternative approach, as disclosed e.g. by WO 95/07000, Abstract or EP 0 886 440 A2, FIG. 2, uses CCD cameras. The images recorded by the CCD camera are digitized, compressed and stored in a memory. JPEG is used as the compression technique, which provides high resolution. For example, a 4096×4096-pixel image is compressed within 6 seconds and stored as a 600-k-byte data packet. The stored image can be transmitted, for example, via an optical network and a 1-Mbit/s connection. Construction, installation, servicing and maintenance of the optical network are very cost-intensive. If, for example, 3 images are to be transmitted per second, then extra hardware and 18-Mbit/s connections are required therefor.

### SUMMARY OF THE INVENTION

It is an object of the invention to provide a monitoring system which minimizes the disadvantages of the prior art.

This object is achieved by a method for storing images recorded by a digital camera, including the steps:

compression of the recorded images by a compression technique having a first resolution,

compression of the recorded images by a compression technique having a second resolution, which is lower than the first resolution, and

storage of the images compressed at the first resolution and the images compressed at the second resolution, while using time codes which respectively create a link between corresponding images;

a method for transmitting images recorded by a digital camera via a telecommunication network, further including the steps:

compression of the recorded images by the compression technique having a first resolution,

compression of the recorded images by a compression technique having a second resolution, which is lower than the first resolution,

storage of the images compressed at the first resolution, while using time codes which respectively create a link to a corresponding image compressed by the compression technique having the second resolution,

transmission of the images compressed by the compression technique having the second resolution via the telecommunication network, and

transmission of an image compressed by the compression technique having the first resolution via the telecommunication network after receiving an associated time code from the telecommunication network;

a monitoring instrument, containing a digital camera for recording images or an interface to such a camera, a digital memory and a first compressor for compressing the recorded images at d first resolution, a second compressor for compressing the recorded images at a second resolution, which is lower than the first resolution, and a control unit for controlling the storage of the images compressed at the first resolution and of the images compressed at the second resolution, in such a way that time codes are used which respectively create a link between corresponding images,

as well as a device for evaluating images recorded by a digital camera and subsequently compressed at a first resolution, containing a digital memory, a first decompressor for decompressing the images compressed at the first resolution, and a second decompressor is provided for decompressing the images, recorded by the digital camera, which have been compressed at a second resolution which is lower than the first resolution and

a monitoring instrument containing a digital camera for recording live images and an interface to a radio network, a transmitter being provided for transmitting the recorded live images via the radio network, and a receiver being provided for receiving control signals from the radio network, and the receiver being suitable for adjusting the number of images to be recorded per second by the digital camera as a function of the received control signals, at least three live images being recorded per second.

According to the invention, in particular, live images from a CCD camera are compressed in two different ways in a monitoring instrument. On the one hand, compression is carried out at a low resolution, for example by means of H.261, H.263 or MPEG. On the other hand, compression is carried out at a high resolution, for example by means of JPEG, synchronously with the compression at the low resolution. A time code is generated for each image. The time code is, for example, a chronological code which contains the date and time of day. The time code can also be generated implicitly via a timer which runs simultaneously. Each image is stored twice, on the one hand as an image compressed at low resolution and, on the other hand, as an image compressed at high resolution. The time codes which indicate links between corresponding images are also stored. In an advantageous configuration, the images compressed at the low resolution are transmitted continuously via a telecommunication network to an evaluation device. The latter is, for example, part of a control facility which undertakes the central monitoring of a plurality of public places. The images compressed at the high resolution are transmitted only in special cases. Such a case exists, for example, when a single image arouses interest during review, for example a suspect is easily identifiable on this single image. By means of the time code, the associated image compressed at the high resolution can then be detected and transmitted.

The telecommunication network used is, for example, ISDN, XDSL, UMTS or the like. In ISDN, the transmission can be carried out via narrow-band connections, for example by means of 64 kbit/s in the so-called B channel or even 16 kbit/s in the so-called D channel.

When an image which seems to show a criminal or something of interest is received in the control facility, then a request to transmit the corresponding image compressed at the high resolution can be sent to the monitoring instrument. The request contains the time code of the relevant image. By means of the time code, it is easy to identify the corresponding image in the monitoring instrument. The memory in the monitoring instrument has, for example, a capacity of 24 hours. Therefore, even events from several hours in the past can be dealt with and corresponding images compressed at high resolution can be requested. The memory is, for example, configured as a ring memory which is automatically overwritten with new live images after 24 hours. The monitoring instrument is part of a monitoring system which has at least one control facility, which is connected to a multiplicity of monitoring instruments via a telecommunication network. The monitoring system monitors, for example, public places, football stadiums, metros, etc. For example, 3 images are recorded per second and at least 3 high-resolution images are stored per second. If JPEG is used for the compression at the high resolution, then, for example, 1.3 million bytes are used to store an image. If ISDN is used for transmitting the JPEG images, then the JPEG images are firstly divided into individual data packets, which are then transmitted in chronological succession, for example via a 64-kbit/s line. The current live images at low resolution can be transmitted synchronously with selected images at high resolution if, in ISDN, for example one B channel is used for each resolution or the D channel is used for the low resolution and a B channel is used for the high resolution. Alternatively, it is also possible to use narrow-band transmission via ISDN for the images at low resolution and ADSL for the images at high resolution. In this case, both an ISDN interface and an ADSL interface are to be provided in the transmission instrument. Alternatively, it is also possible to use narrow-bond radio transmission, for example GSM, for the images at low resolution and broadband radio transmission, for example GPRS or EDGE or UMTS, for the images at high resolution. To save memory, for example only those images on which a difference from the preceding image has been detected are compressed. A corresponding detector is to be provided in the monitoring device.

The invention thus discloses a low-cost monitoring system having high resolution. For example, only two 64-kbit/s ISDN connections are needed, instead of 18-Mbit/s connections. The images are transmitted via existing networks, e.g. via ISDN and/or leased lines. This saves on servicing and maintenance costs. The invention is compatible with all types of telecommunication networks, for example ISDN, XDSL, wireless ATM, HFR, UMTS, HFC, etc. The invention is suitable, in particular, for use in large-scale organised scenarios, for example at the 2006 World Cup in Germany. An advantage of the invention is that events in the post can also be monitored at high resolution. Depending on the size of the memory in a monitoring instrument, it is possible to cover periods ranging from 24 hours to days. Precisely in the case of unforeseen events, for example the attack on the metro in Moscow or Japan, the probability of detecting and identifying suspects can hence be increased by means of the high resolution. The leader in the field of public surveillance cameras is the United Kingdom, in particular London. One million analogue monitoring cameras have already been installed in London, especially in public places. By means of the invention, the quality of the monitoring and, in particular, the possibility of identifying individuals, as well as the use for photographs for search purposes, can be increased significantly in a cost-effective way. Another advantage of the invention is that the monitoring instruments can be embodied as small compact modules, which can be used in a mobile fashion. A monitoring instrument having a radio-network interface and an independent power supply, for example using a solar panel or a battery, can be used at any desired location within a radio network. A monitoring instrument having an ISDN interface can be connected in any home with ISDN access and, for example, can be installed on the balcony. The control facility can also be used in a mobile fashion, for example by arranging it in a motor vehicle.

Advantageous configurations of the invention can be found in the dependent claims and the following description.

### BRIEF DESCRIPTION OF THE DRAWINGS

Four exemplary embodiments of the invention will be explained below with the aid of five figures, in which:

FIG. 1 shows a schematic representation of a monitoring system according to the invention,

FIG. 2 shows a schematic representation of a monitoring instrument according to the invention,

FIG. 3 shows a schematic representation of a monitoring instrument according to the invention having two digital cameras,

FIG. 4 shows a schematic representation of another monitoring instrument according to the invent ion having two digital cameras, and

FIG. 5 shows a schematic representation of another monitoring instrument according to the invention having two digital cameras.

### BEST MODE FOR CARRYING OUT THE INVENTION

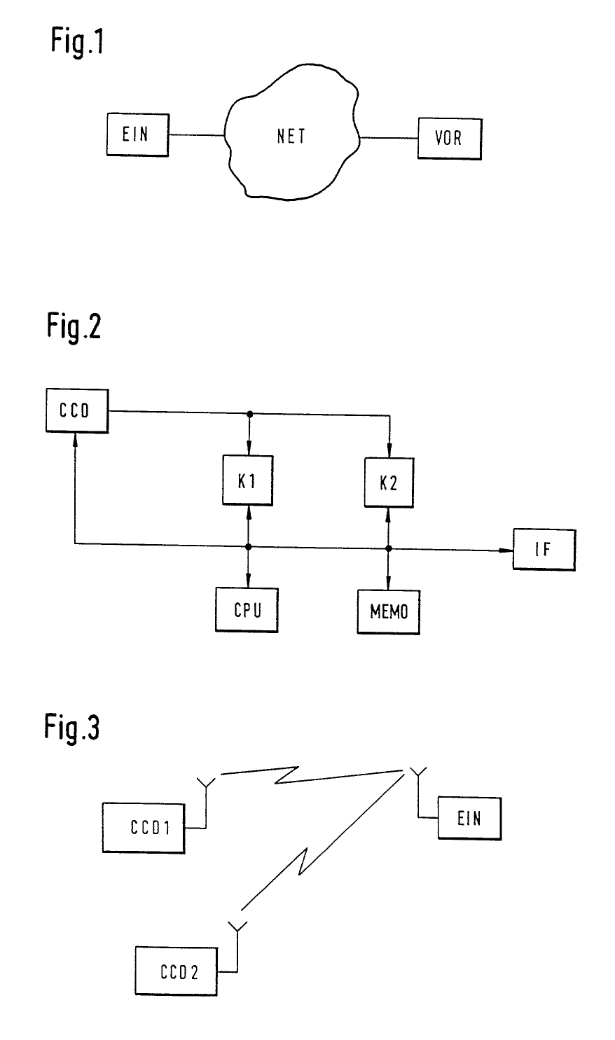

The first exemplary embodiment will now be explained first with the aid of FIG. 1. FIG. 1 shows a monitoring system.

The monitoring system contains at least one monitoring instrument INS and at least one device DEV for evaluating images. The monitoring instruments and the devices are connected to one another via at least one telecommunication network NET.

A telecommunication network NET is, for example, configured as ISDN, ADSL, XDSL, SDSL, Internet, HFC, HFR, ATM, wireless ATM, UMTS, GSM, GPRS, EDGE, an optical network, LMDS or a radio relay network; HFC=hybrid fiber coax, HFR=hybrid fiber radio.

A method for storing images recorded by a digital camera will be described below. The method is characterised by:

compression of the recorded images by a compression technique having a first resolution,

compression of the recorded images by a compression technique having a second resolution, which is lower than the first resolution, and

storage of the images compressed at the first resolution and the images compressed at the second resolution, while using time codes which respectively create a link between corresponding images.

The compression at the low resolution and the compression at the high resolution take place synchronously. Using the time codes which, in the simplest case, are determined by a timer which runs simultaneously and contain the date and time of day, including tenths of a second, it is easy to identify corresponding images, that is to say images having the same content but a different resolution. Instead of the time codes, however, it is also possible to use other codes, for example containing the memory address of the two corresponding images or an identifier which is the same for two corresponding images and is re-generated in each case. Nevertheless, it is particularly advantageous to use time codes since they also contain proof of the day and the time of day when the respective image was recorded, which can subsequently be used as evidence where appropriate. The double storage provides the possibility of transmitting low-resolution images without having to do without the high-resolution images when the latter are desired in special cases. Owing to the storage, it is always possible, that is to say up to the capacity of a ring memory which is used, subsequently to provide a high-resolution image corresponding to a low-resolution image. The storage of the images at low resolution is generally used only for temporary storage before transmission via the telecommunication network. As soon as a low-resolution image has been transmitted, it can be overwritten by a high-resolution image, so that memory can be saved. Memory can likewise be saved by storing high-resolution images only for the case in which a change from the preceding image has occurred. If, for example, no event has occurred at night in the recording range of the camera, then it is feasible for only one high-resolution image to have been recorded throughout the night, or for all he high-resolution images to have been constantly overwritten so that only one memory location has been occupied. The capacity of the ring memory can therefore be optimally utilised. A ring memory which, for example, is embodied as RAM or as a replaceable writable CD, can therefore record high-resolution images for several hours or even days.

A method for transmitting images recorded by a digital camera via a telecommunication network will be described below. The method is characterised by:

compression of the recorded images by the compression technique having a first resolution,

compression of the recorded images by a compression technique having a second resolution, which is lower than the first resolution,

storage of the images compressed at the first resolution, while using time codes which respectively create a link to a corresponding image compressed by the compression technique having the second resolution,

continuous transmission of the images compressed by the compression technique having the second resolution via the telecommunication network, and

transmission of an image compressed by the compression technique having the first resolution via the telecommunication network after receiving an associated time code from the telecommunication network.

Images at high resolution are generally transmitted synchronously with images at low resolution. Images at high resolution always have a different content from images at low resolution when they are being transmitted synchronously. This is due to the fact that the images at high resolution are transmitted only on request and after having received the associated images at low resolution. While the images at high resolution are being transmitted, however, it is also possible to suspend transmission of the images at low resolution. This is done, for example, to save on transmission capacity. A low-resolution image is always transmitted with a time code. If an associated high-resolution image is requested, then this is done by a request containing the time code. It is possible to identify the associated high-resolution image with the aid of the tire code. High-resolution images are stored in the monitoring instrument INS. Low-resolution images are transmitted directly after they have been recorded and after the time code has been assigned. They can be optionally temporarily stored. The recorded images are generally live images.

The first exemplary embodiment will now be explained with the aid of FIG. 2. FIG. 2 shows a monitoring instrument.

The monitoring instrument INS contains a digital camera CCD for recording images or, alternatively, an interface to such a camera. Also provided are a digital memory MEMO, a first compressor K1 for compressing the recorded images at a first resolution, and a second compressor K2 for compressing the recorded images at a second resolution, which is lower than the first resolution. A control unit CPU is furthermore provided for controlling the storage of the images compressed at the first resolution and of the images compressed at the second resolution, in such a way that time codes are used which respectively create a link between corresponding images.

The digital camera is, for example, a CCD camera, the first compressor K1 is, for example, a JPEG compressor and the second compressor is, for example, an H.261, H.263 or MPEG compressor. The references to JPEG, H.261, H.263 and MPEG are references to the standards of the same name, and are intended to refer to versions already existing as well as future versions.

The memory MEMO is configured, for example, as a ring memory, the capacity being configured in such a way that overwriting does not take place until after several hours.

An interface to the telecommunication network NET is provided in the monitoring instrument INS. The control unit CPU is suitable for reading images from the memory MEMO and transmitting them to the telecommunication network NET via the interface, the transmission capacity being the same for the images compressed at the first resolution and for the images compressed at the second resolution. The telecommunication network is, for example, ISDN. In the basic access configuration, two 64-kbit/s channels and one 16-kbit/s channel are available. The two 64-kbit/s channels are the two B channels. They are available for transmitting useful information. The 16-kbit/s channel is the D channel, which is used for signalling purposes. It can also be used additionally for packet data transmission. The images compressed in the second compressor K2 having low resolution are transmitted, for example, via a B channel. One B channel is, for example, connected as always-on, so that low-resolution images are continuously transmitted to the device DEV. Alternatively, for example the device DEV can be dialled up only on demand by the monitoring instrument INS which, for example, has the functionality of a terminal, for example a telephone. The low-resolution images are then transmitted only when the device DEV has been dialled up. This saves on charges, but has the disadvantage that the device DEV is not constantly informed. The transmission can also be carried out intermittently. For example, three images are recorded per second. However, an image is transmitted only every two seconds. This has the advantage that transmission charges can be saved. At the same time, there is no loss of quality for the high-resolution images, since they continue to be stored at three images per second. This ensures that, when high-resolution images are subsequently requested, they are all available. Time codes, for example, with a consecutive number are allocated for the images. In order to request high-resolution images which relate to images that lie between transmitted images at low resolution, the corresponding time code or time codes can therefore be generated straightforwardly and transmitted as a request. The images compressed in the first compressor K1 having low resolution are, for example, transmitted via a further B channel. The further B channel is, for example, connected only when transmission is taking place.

In a preferred embodiment, the images compressed in the second compressor K2 having low resolution are transmitted, for example, via the D channel, and the images compressed in the first compressor K1 having high resolution are, for example, transmitted via a B channel. The high resolution works, for example, with JPEG and uses, for example, 1.3 million bytes to store an image. For transmission via a B channel, a JPEG image is divided into sub-images and subsequently transmitted in data packets matched to the corresponding data rate, for example at 16 kbit/s or 64 kbit/s.

In another preferred embodiment, the images compressed in the second compressor K2 having low resolution are transmitted, for example, via the D channel, and the images compressed in the first compressor K1 having high resolution are, for example, transmitted via the two B channels or more than two B channels.

In another preferred embodiment, the images compressed in the second compressor K2 having low resolution are transmitted, for example, via one or two B channels, and the images compressed in the first compressor K1 having high resolution are transmitted, for example, via a 2-Mbit/s connection using ADSL. The telecommunication network works, for example, with ADSL and ISDN. For ADSL, because of the higher data rate, higher charges are incurred than for ISDN. The low-resolution images are therefore transmitted cost-efficiently via ISDN, and the high-resolution images are transmitted on demand via ADSL. Because of the high data rate of 2 Mbit/s, the high-resolution images are, for example, transmitted just as fast as the low-resolution images.

In another preferred embodiment, the monitoring instrument INS contains an interface to a radio network. The control unit CPU is suitable for reading images from the memory MEMO and transmitting them to the mobile radio network via the interface, the transmission capacity for the images compressed at the first resolution being higher than the transmission capacity for the images compressed at the second resolution. With GSM, the transmission is carried out, for example, in 9.6-kbit/s channels. For example, one channel is used for transmitting the low-resolution images. The transmission of the high-resolution images uses, for example GPRS in which eight 9.6-kbit/s channels are connected together so that a higher data rate is generated. It is also possible for the low-resolution images to be transmitted by means of GPRS and for the high-resolution images to be transmitted by means of EDGE. Alternatively, the transmission can also be carried out via UMTS. In UMTS, the data rates can be set individually. Depending on the number of images recorded per second, a suitable data rate is selected for the low-resolution images and the high-resolution images. The data rates for the low-resolution images and the high-resolution images can in this case be the same or different. The high-resolution images can be transmitted synchronously with the low-resolution images, or the transmission of the low-resolution images may be suspended during the transmission of the high-resolution images. The reference to low-resolution images is a shorthand expression for the images recorded by the digital camera which have been compressed by means of the second compressor K2. The reference to high-resolution images is a shorthand expression for the images recorded by the digital camera which have been compressed by means of the first compressor K1.

The control unit CPU is, for example, configured as a DSP and is connected to the digital camera CCD, and controls the latter in such a way that it records at least two or three live images per second.

The device DEV in FIG. 1 for evaluating images recorded by the digital camera CCD and subsequently compressed at the first resolution is connected to the monitoring instrument INS via the telecommunication network NET. The device DEV contains a digital memory, a first decompressor for decompressing the images compressed at the first resolution and a second decompressor for decompressing the images, recorded by the digital camera, which have been compressed at a second resolution which is lower than the first resolution. The first decompressor is, for example, a JPEG decompressor. The second decompressor is, for example, an H.261, H.263 or MPEG decompressor. The digital memory used is, for example, a RAM, a DRAM, a flash memory, an EPROM, a writable CD, an electrical or optical memory or the like.

The device DEV contains a control unit for detecting time codes associated with the images. The control unit is, for example, configured as a DSP and is suitable for transmitting a detected time code to the telecommunication network via the interface. The time code is transmitted to the monitoring instrument INS. The transmission is carried out, for example, via the D channel of the ISDN. The monitoring instrument INS receives the time code, and the control unit CPU identifies the associated high-resolution image and subsequently transmits it to the device DEV which, for example, is designed as a coordination center or control facility of a monitoring system, or constitutes a mobile device which, for example, can be used in a police patrol vehicle. The telecommunication network can, for example, be a radio network such as GSM. The patrol vehicle or the device has an interface to the radio network and is thereby capable, in particular, of receiving the high-resolution images at any desired location and, for example, printing them out and using them in situ as photographs for search purposes.

In a preferred embodiment, the device DEV can also be used to evaluate two, three, four or more cameras. The device DEV contains, for example, a plurality of interfaces to the telecommunication network NET. This is done via a primary multiplex access having 30 B channels, for example, for linking to the ISDN. In this way, for example, images from 30 different cameras can be received simultaneously. Each channel is provided, for example, with a decompressor for decompressing the images compressed at the second resolution, i.e. 30 decompressors in total. Since the high-resolution images are transmitted, and subsequently evaluated, only infrequently and only on request, it is sufficient to provide only one decompressor for decompressing the images compressed at the first resolution. This reduces the hardware outlay and the production costs. The 30 images at low resolution can be displayed simultaneously on 30 monitors or, in multiplex, for example on 10 monitors.

If an employee in the control facility then recognises a disturbance in one or more transmitted images, for example an attack or a fight, then he or she can, for example, switch over to the images compressed at the high-resolution, zoom and pan the CCD camera telemetrically, or read out or rewind the ring memory before it is overwritten, and monitor the incident history and request a corresponding single high-resolution image via a time code. For the duration of the disturbance, it is possible for example to switch to always-on transmission via ADSL. Although this entails higher charges, these are justified according to the situation. By zooming and panning, it is possible to home in on the individual causing the disturbance and prepare a very sharp image by means of the high-resolution images. The control instrument in the corresponding monitoring instrument INS reacts to the control signals from the device DEV and carries out the corresponding actions, e.g. panning, zooming or transmitting an image at high resolution.

The second exemplary embodiment will now be explained with the aid of FIG. 3. FIG. 3 shows a monitoring instrument and two digital cameras.

The monitoring instrument INS contains an interface to a radio network and processing means for at least two cameras. The radio network can be: GSM, GRPS, EDGE, UMTS, service radio, DECT or the like. In on-site monitoring instruments, a respective digital camera CCD1, CCD2 for recording live images and an interface to the radio network are provided, as well as a transmitter for transmitting the recorded live images via the radio network and a receiver for receiving control signals from the radio network. The control signals are transmitted from the monitoring instrument INS to the cameras CCD1, CCD2 and contain, for example, control signals for zooming, panning or for the number of images to be recorded per second by the respective camera CCD1, CCD2. The receiver is suitable for setting the number of images to be recorded per second by the digital camera CCD1, CCD2 as a function of the received control signals, at least three live images being recorded per second. The receiver contains therefor a correspondingly programmed processor, for example a DSP. Around a public place, for example, a plurality of cameras may be arranged which are controlled via a central monitoring instrument INS. It is particularly advantageous that the cameras can be placed at arbitrary positions. If the cameras are equipped with a separate power supply, for example a solar panel or a battery, the degree of freedom for placement is even higher. The cameras can, for example, be arranged inside a UMTS picocell or microcell. The monitoring instrument INS contains, for example, a base station.

The third exemplary embodiment will now be explained with the aid of FIG. 4. FIG. 4 shows a monitoring instrument and two digital cameras.

The monitoring instrument INS is connected via two interfaces to two on-site digital cameras CCD1, CCD2 which are intended to record images. The connection is carried out, for example, via electrical lines, optical lines or radio. A multiplexer, which is used for multiplexing the recorded images, is provided in the monitoring instrument INS. The recorded images are transmitted in time-division multiplex to the compressors, which carry out the compression. The images from both cameras CCD1, CCD2 are subsequently stored. The low-resolution images from both cameras CCD1, CCD2 are transmitted, for example via ISDN, to an evaluation device which has a demultiplexer that decombines the images so that they can be displayed on different monitors. Alternatively, the control unit CPU may also carry out separation before broadcasting, and transmit the images at low resolution from the camera CCD1, for example, via one B channel and the images at low resolution from the camera CCD2, for example, via another B channel. A device as described with respect to FIG. 2 can be used for the evaluation.

The structure and functionality of the other elements correspond to the elements of the some name in FIG. 2.

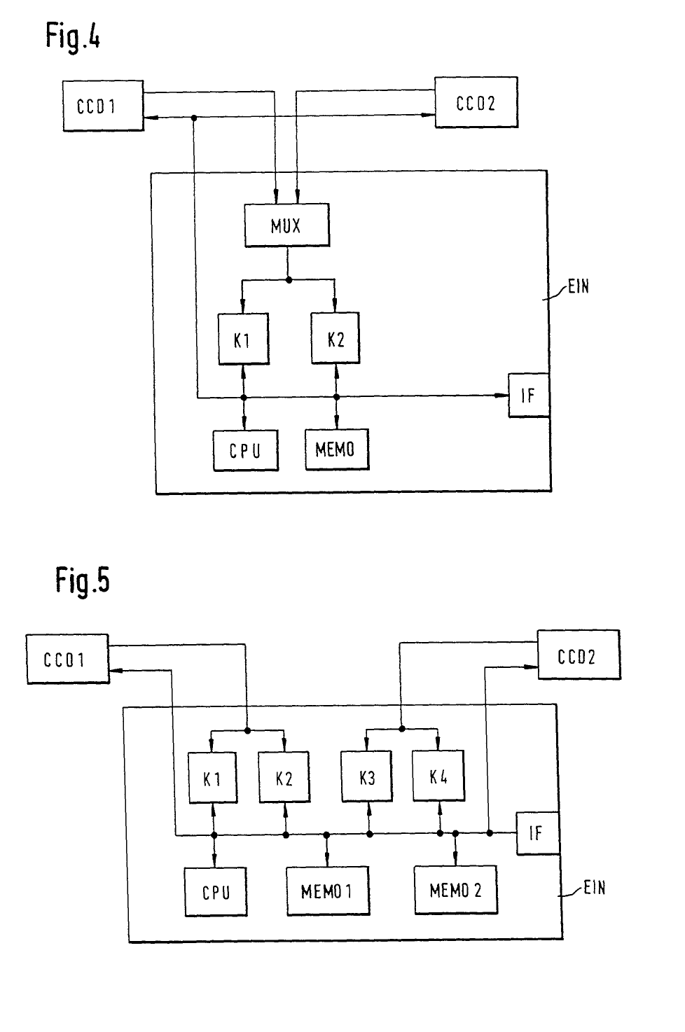

The fourth exemplary embodiment will now be explained with the aid of FIG. 5. FIG. 5 shows a monitoring instrument and two digital cameras.

The monitoring instrument INS contains, in addition to the compressors K1 and K2, a third compressor K3 for compressing the images recorded by the camera CCD2 at a third resolution and a fourth compressor K4 for compressing the images recorded by the camera CCD2 at a fourth resolution. The third resolution can be selected to be the same as the first resolution or different therefrom. The fourth resolution can be selected to be the same as the second resolution or different therefrom. The resolutions can be set telemetrically via the telecommunication network. Two memories MEMO1 and MEMO2 are provided, which are used to store the compressed images from the camera CCD1 and the images from the camera CCD2, respectively. The images at low resolution from the camera CCD1 are transmitted, for example, via one B channel of the ISDN and the images at low resolution from the camera CCD2 are transmitted, for example, via another B channel. The images at high-resolution are transmitted, for example, via ADSL or one or two B channels.

The structure and functionality of the other elements correspond to the elements of the same name in FIG. 2.

The exemplary embodiments list examples which can be combined with one another. Compression is used for pre-processing the images from the digital cameras. It is also possible to use encoding instead of compression. Further to the monitoring of public places and/or public concerns, the monitoring instruments can also be used for private purposes.

The elements within a monitoring instrument are advantageously connected to one another via a data bus or a bus system. Instead of transmission via a telecommunication network, the stored image data can also be collected by an employee during his or her rounds. During collection, for example, written CDs are replaced by new CDs to be written. In this way, it is possible to collate an archive of high-resolution images, which can optionally be used for documentation purposes or, alternatively, can be used as evidence material for events further in the past.

1. Method for storing images recorded by a digital camera, including the steps:
compression of the recorded images by a compression technique having a first resolution,
compression of the recorded images by a compression technique having a second resolution, which is lower than the first resolution, and
storage of the images compressed at the first resolution and the images compressed at the second resolution, while using time codes which respectively create a link between corresponding images.

2. Method for transmitting images recorded by a digital camera via a telecommunication network, further including the steps:
compression of the recorded images by the compression technique having a first resolution,
compression of the recorded images by a compression technique having a second resolution, which is lower than the first resolution,
storage of the images compressed at the first resolution, while using time codes which respectively create a link to a corresponding image compressed by the compression technique having the second resolution,
transmission of the images compressed by the compression technique having the second resolution via the telecommunication network, and
transmission of an image compressed by the compression technique having the first resolution via the telecommunication network after receiving an associated time code from the telecommunication network.

3. Monitoring instrument, containing a digital camera for recording images or an interface to such a camera, a digital memory and a first compressor for compressing the recorded images at a first resolution, a second compressor for compressing the recorded images at a second resolution, which is lower than the first resolution, and a control unit for controlling the storage of the images compressed at the first resolution and of the images compressed at the second resolution, in such a way that time codes are used which respectively create a link between corresponding images.

4. Monitoring instrument according to claim 3, the digital camera being a CCD camera, the first compressor being a JPEG compressor, and the second compressor being an H.261, H.263 or MPEG compressor, which is suitable for real-time compression.

5. Monitoring instrument according to claim 3, the memory being configured as a ring memory, the capacity being configured in such a way that overwriting does not take place until after several hours.

6. Monitoring instrument according to claim 3, containing an interface to a telecommunication network, and the control unit being suitable for reading images from the memory and transmitting them to the telecommunication network via the interface, the transmission capacity being the same for the images compressed at the first resolution and for the images compressed at the second resolution.

7. Monitoring instrument according to claim 3, containing an interface to a mobile radio network, and the control unit being suitable for reading images from the memory and transmitting them to the mobile radio network via the interface, the transmission capacity for the images compressed at the first resolution being higher than the transmission capacity for the images compressed at the second resolution.

8. Monitoring instrument according to claim 3, the control unit being connected to the digital camera and controlling the latter in such a way that it records at least three live images per second.

9. Monitoring instrument according to claim 3, wherein at least two interfaces to at least two digital cameras for recording images are provided, and in that a multiplexer is provided for multiplexing the recorded images, or at least a third compressor for compressing the recorded images from a camera at a third resolution and at least a fourth compressor for compressing the recorded images from a camera at a fourth resolution are provided.

10. Device for evaluating images recorded by a digital camera and subsequently compressed at a first resolution, containing a digital memory, a first decompressor for decompressing the images compressed at the first resolution, and a second decompressor is provided for decompressing the images, recorded by the digital camera, which have been compressed at a second resolution which is lower than the first resolution.

11. Device according to claim 10, while an interface to a telecommunication network is provided, in that a control unit is provided for detecting time codes associated with the images, and in that the control unit is suitable for transmitting a detected time code to the telecommunication network via the interface.

12. Monitoring instrument containing a digital camera for recording live images and an interface to a radio network, a transmitter being provided for transmitting the recorded live images via the radio network, and a receiver being provided for receiving control signals from the radio network, and the receiver being suitable for adjusting the number of images to be recorded per second by the digital camera as a function of the received control signals, at least three live images being recorded per second.
